(19) United States
(12) Patent Application Publication
(10) Pub. No.: US 2008/0302015 A1
(43) Pub. Date: Dec. 11, 2008

(54) RF-remote control, retrofitted, self-contained, automatic window opener for casement windows or the like

(76) Inventor: KENNETH WILLIAM THORNE, CARBONDALE, CO (US)

Correspondence Address: THOMTE LAW OFFICE, L.L.C., 2120 S. 72ND STREET, SUITE 1111, OMAHA, NE, 68124, US

(21) Appl. No.: 11/983,036

(22) Filed: Nov. 6, 2007

Related U.S. Application Data
(60) Provisional application No. 60/933,508, filed on Jun. 7, 2007.

(51) Int. Cl. E06B 7/00

(52) U.S. Cl. 49/70

(57) ABSTRACT

An RF-remote control, retrofitted, self-contained, automatic window opener is provided for casement windows or the like which includes a housing having a DC motor therein which has a power shaft extending therefrom. The DC motor is powered by a battery source contained within the housing. The power shaft of the DC motor is selectively removably secured to the drive shaft of a conventional casement window opener mechanism so that the DC motor may rotate the drive shaft in either direction to open or close the sash of the casement window. The window opener of this invention is mounted within a housing which has anti-rotation members selectively adjustably extending therefrom which engage the window frame to prevent rotation of the unit when the motor is activated. The unit includes an electrical circuit which has an RF receiver associated therewith which is controllable by a remote RF transmitter to enable a person to remotely control the opening and closing of a casement window.

### CROSS-REFERENCE TO RELATED APPLICATION

This application claims the benefit of U.S. Provisional Application Ser. No. 60/933,508 entitled “AUTO WINDOW WIZARD” filed Jun. 7, 2007, the disclosure of which is hereby incorporated herein by reference.

### BACKGROUND OF THE INVENTION

1. Field of the Invention

This invention relates to an opener for a casement window more particularly to an opener which is designed to open casement windows automatically, with an RF signal, activating a single fully self-contained or multiple fully self-contained units which may be placed on windows in different locations and/or on different floors and which are controlled by a hand-held or wall-mounted remote controller or electronic timer.

2. Description of the Related Art

Casement windows have been widely used for many years. Generally speaking, most casement windows include a window sash which is pivotably movably mounted in a window frame. Casement windows normally employ a hand crank that drives a worm gear with the worm gear being meshed with a gear segment which is part of a lever or linkage assembly that is connected to the sash. When the crank is turned, the worm gear causes the gear segment and lever to move to cause the sash to pivot on its hinges between open and closed positions. The inner end of the crank usually includes a female, splined-socket which is selectively removably mounted on a male splined shaft which is operatively connected to the worm gear.

Although many remotely controlled mechanisms have been provided for a window operator for use in moving a casement window sash between open and closed positions with respect to a casement window frame, the same are believed to be impractical since the same require substantial modification of the casement window operator and which normally occupy a very large amount of space. Further, the prior art devices are not self-contained.

### SUMMARY OF THE INVENTION

The window operator of this invention is designed to attach to the male shaft of the opening mechanism of a casement window by replacing the crank handle which is normally mounted on the male shaft. The unit of this invention may be placed in any window which it is desired to automatically controlled, utilizing an internal self-contained standard or rechargeable battery source. The remotely controlled mechanism of this invention consists of a plastic housing in the shape of an egg or other design, of which, the top half is removable. Inside the housing is a nine volt electric mini-gear-boxed DC motor with a limit switch or time controlling electronic circuit. The internal power supply provides power to operate the motor and the self-contained controlling electronic circuits. The unit includes a circuit board which contains an RF receiver and a timed overload opening and closing circuit for controlling the operation of the unit.

The unit includes a female socket protruding from the lower end thereof which is splined or slotted to match the geared male shaft on the conventional actuating mechanism of the window. The unit is easily installed on the male shaft after the conventional crank handle has been removed therefrom. The unit also includes a straddling mechanism which straddles the window mechanism to prevent auto-rotation of the unit when activated in either direction.

The unit of this invention opens and closes windows in single or multiple numbers, automatically, with the touch of a button, wirelessly. Through the use of an additional master control panel, it is possible to program the opening and closing of the windows at certain times of the day or night if desired. Preferably, the unit includes a rain sensor which reports, wirelessly, raindrops on the sash and closes the window. Preferably, a wind sensor detects high winds and closes the windows and can reopen them once the conditions clear.

The unit of this invention creates an energy efficient solar radiation control mechanism for businesses or homes. The user may open single windows on one floor or many windows on separate floors for ventilation and energy efficiencies. The opening of windows at night can cool a residence while closing them in the morning can seal in and preserve the cooler night-time temperatures longer during the daylight hours. Elderly persons can open and close the windows with the ease of a button.

It is therefore a principal object of the invention to provide a unique remotely controlled, self-contained mechanism for a window operator for use in moving a casement window sash between open and closed positions with respect to a casement window frame.

A further object of the invention is to provide a unit of the type described which enables a person to open and close one or more windows through a remotely controlled mechanism.

Still another object of the invention is to provide a unit of the type described which is easily attached to the male-splined shaft of a casement window operator once the crank handle has been removed therefrom.

Still another object of the invention is to provide a unit of the type described which may be programmed to open and close windows in the event or rain, wind or other conditions.

Still another object of the invention is to provide a unit of the type described which is easily mounted on a casement window operator.

Still another object of the invention is to provide a unit of the type described which is remotely controlled.

These and other objects will be apparent to those skilled in the art.

### BRIEF DESCRIPTION OF THE DRAWINGS

FIG. 1 is a partial perspective view of a conventional casement window having a crank handle removably mounted thereon with the RF-remove control adapted to be mounted on the male splined shaft of the window operator;

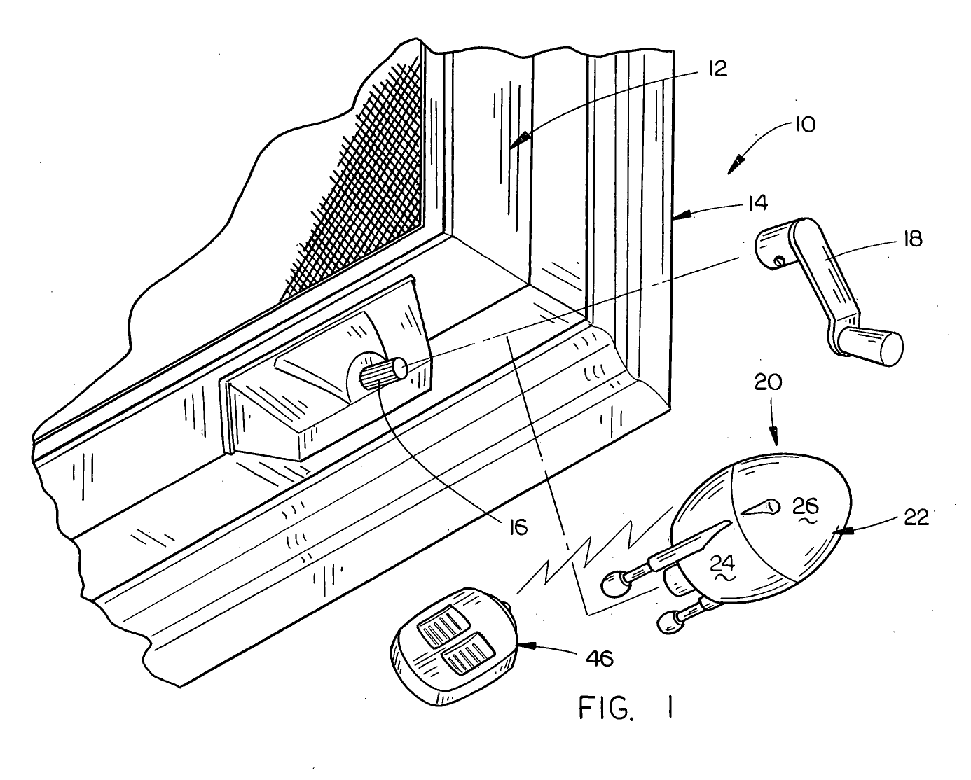

FIG. 2 is an exploded perspective view of the opener of this invention;

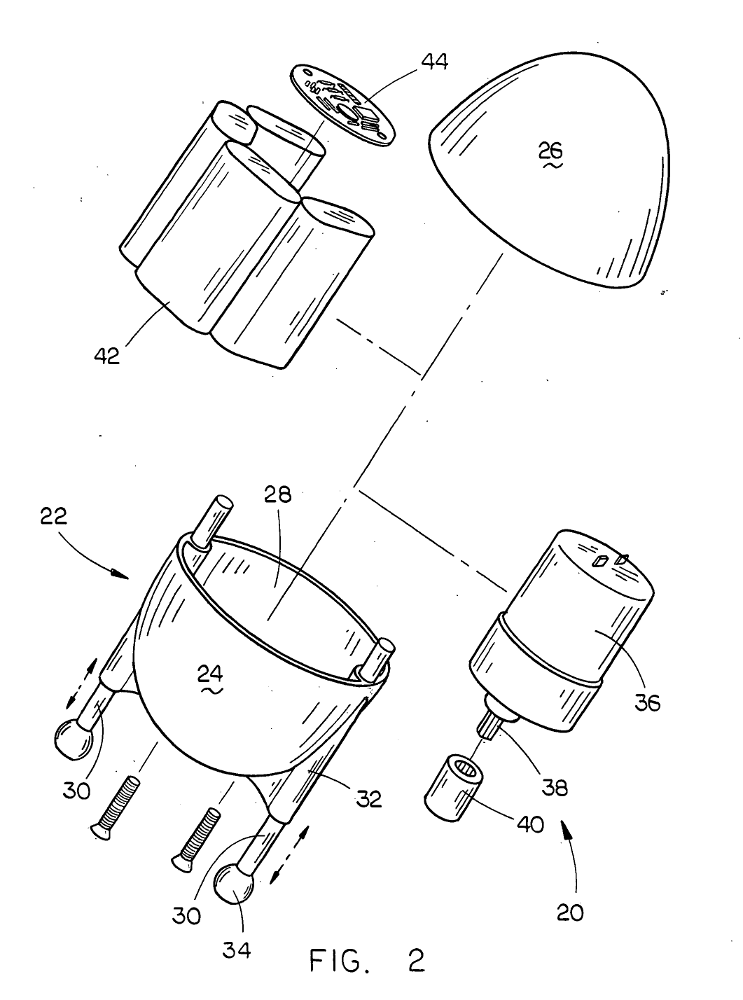

FIG. 3 is a sectional view illustrating the window opener of this invention mounted on the male splined shaft of the opener of the casement window; and

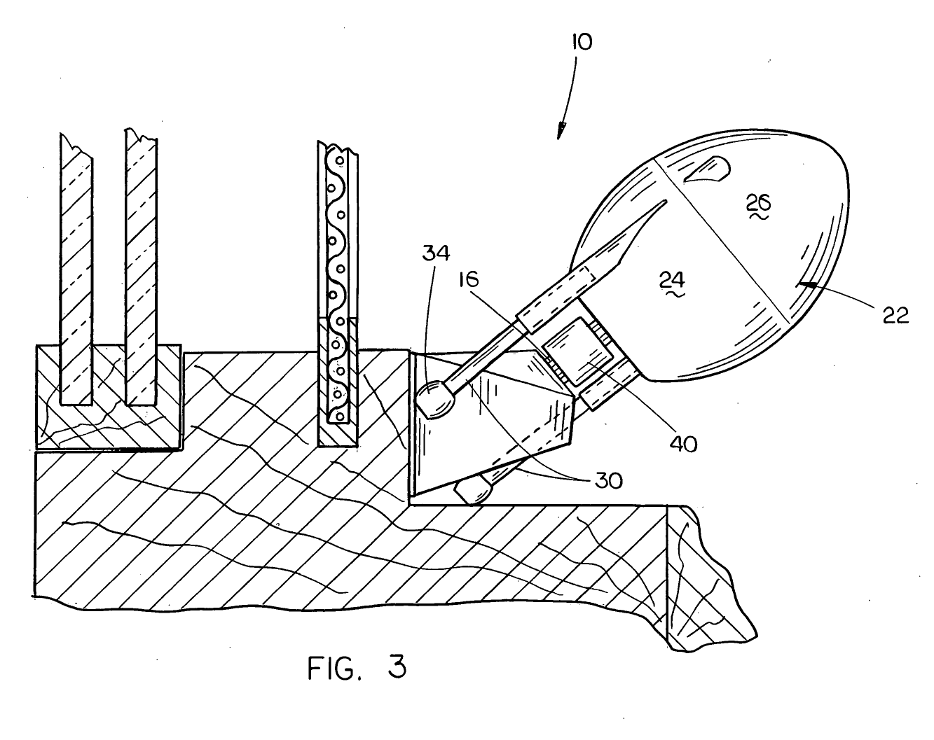

FIG. 4 is a sectional view of the window opener of this invention.

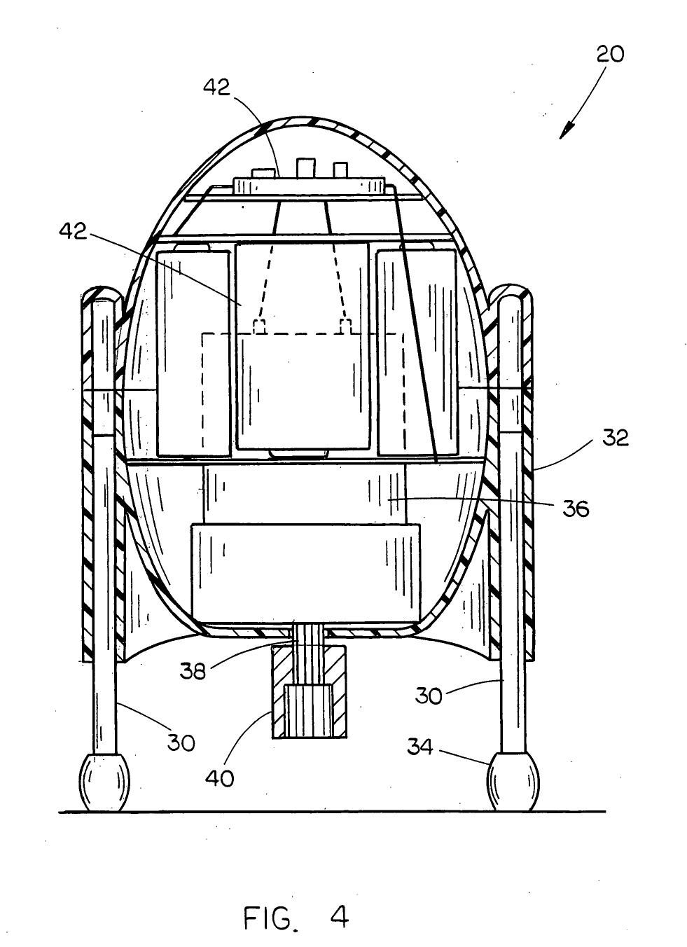

### DETAILED DESCRIPTION OF THE INVENTION

The numeral 10 refers generally to a conventional casement window including a sash 12 movably mounted in a casement window frame 14. The conventional casement window 10 includes a conventional opener mechanism (not shown) which includes a male splined shaft 16 having a crank handle 18 removably mounted thereon. The opener mechanism normally includes a worm gear which is operatively connected to the shaft 16 with the worm gear being meshed with a gear segment which is part of a lever or linkage assembly that is connected to the sash 12 to move the same between open and closed positions in conventional fashion.

The numeral 20 refers to the self-contained RF-remote control, automatic window opener of this invention which is adapted to be mounted on the shaft 16 after the crank handle 18 has been removed therefrom. Control 20 is mounted within a housing 22 which may take any different shape but which is preferably egg-shaped, as seen in the drawings. Housing 22 includes a hollow lower housing member 24 and an upper housing member 26 selectively secured to housing member 24 to provide an internal compartment 28. Housing 22 includes a plurality of length adjustable legs 30 which are slidably mounted in tubes or sleeves 32 and which have enlarged foot portions 34, preferably of a soft resilient material, which are adapted to be moved into engagement with the window frame or opener mechanism for anti-rotational purposes, as will be described in greater detail hereinafter. Preferably, housing 22 is fabricated from a plastic material.

The numeral 36 refers to a nine-volt, electric mini-gearboxed DC motor with a limit switch or time controlling electronic circuit. Motor 36 includes a splined drive or power shaft 38 which may be operatively coupled to shaft 16 by any convenient means. If shaft 38 is externally splined, as seen in the drawings, an internally splined collar 40 is mounted on shaft 38 with the other end of collar 40 receiving the shaft 16.

The numeral 42 refers to a nine-volt battery pack which is positioned within the housing 22 and which is electrically connected to motor 36 in conventional fashion and to a RF circuit board 44 which includes a RF receiver adapted to receive RF signals from a remote RF transmitter 46 in conventional fashion to control the operation of motor 36 in conventional fashion.

When it is desired to convert a conventional casement window so as to be able to be opened through the RF-remote control, retrofitted, self-contained, opener of this invention, the crank handle 18 is removed from the shaft 16. The control 20 is then mounted on the shaft 16 through the use of the collar 40 or any other conventional means. The adjustable legs 30 are then extended or retracted so as to engage opposite sides of the conventional opener mechanism or the window frame 14 or casement 12 to serve as an anti-rotational mechanism. The unit 20 of this invention may be placed in any window in which it is desired to automatically control, utilizing the self-contained device of this invention. The power supply 42 provides power to operate the motor 36 which contains a limit switch or time controlling electronic circuit. The unit includes the circuit board 44 as described which contains the RF receiver and the timed overload opening and closing circuit to provide control of the operation of the unit. The unit is easily installed on the shaft 16 after the crank handle 18 has been removed therefrom. The anti-rotational straddling mechanism which is comprised of the adjustable legs 30 prevents auto-rotation of the unit when activated in either direction.

The unit of this invention opens and closes windows in a single or multiple numbers, automatically, with a touch of a button, wirelessly. Through the use of an additional master control panel, it is possible to control the opening and closing of the windows at certain times of the day or night if desired. Preferably, the unit includes a rain sensor which reports, wirelessly, raindrops on the sash 12 and closes the window. Preferably, a wind sensor detects high winds and closes the window or windows and can reopen them once the conditions clear.

The unit of this invention creates an energy efficient solar radiation control mechanism for businesses or homes. The user may open single windows on one floor or many windows on separate floors for ventilation and energy efficiency. The opening of windows at night can cool a residence while closing them in the morning can seal in and preserve the cooler night-time temperatures longer during the daylight hours. Elderly persons can open and close the windows with the ease of a button.

It can therefore be seen that the invention accomplishes at least all of its stated objectives.

I claim:

1. In combination with a casement window including a window sash movably mounted in a window frame with the window sash being movable between open and closed positions by a conventional opener mechanism including a drive shaft protruding from the opener mechanism, comprising:
a housing having a DC motor mounted therein which has a selectively reversible power shaft protruding from said housing which is powered by a battery source;
said power shaft adapted to be connected to the drive shaft of the opener mechanism whereby the window sash may be moved between its open and closed positions;
an electrical circuit in said housing for controlling the operation of said motor;
a RF receiver associated with said circuit;
and a remote RF transmitter which is capable of sending RF signals to said RF receiver to remotely open and close the window sash.

2. The combination of claim 1 wherein said housing has a plurality of anti-rotation members extending therefrom for engagement with the window frame.

3. The combination of claim 2 wherein said anti-rotation members are length adjustable.

4. The combination of claim 1 wherein said housing comprises at least a pair of hollow housing members which are selectively secured together.
